(19) United States
(12) Patent Application Publication
(10) Pub. No.: US 2003/0149164 A1
(43) Pub. Date: Aug. 7, 2003

(54) Paint composition for a strippable decorative paint film

(76) Inventors: Marcel Jan Minnee, Valkenburg (NL); Johan Justus Grevers, Alphen a.d. Rijn (NL); Harmen Jelke Kielstra, Amsterdam (NL)

Correspondence Address: Michelle J. Burke, Akzo Nobel Inc., 7 Livingstone Avenue, Dobbs Ferry, NY, 10522-3408, US

(21) Appl. No.: 10/346,016

(22) Filed: Jan. 16, 2003

Related U.S. Application Data
(60) Provisional application No. 60/366,465, filed on Mar. 21, 2002.

(30) Foreign Application Priority Data
Jan. 18, 2002 (NL) 1019786

(51) Int. Cl. C08K 3/00

(52) U.S. Cl. 524/556

(57) ABSTRACT

A paint composition for a removable, decorative coat on a non-porous substrate, such as a car, is described. The paint composition is a pigmented lacquer that forms a film where internal cohesion exceeds adhesion to the substrate. The paint composition contains a binder having a glass transition temperature below 19° C., preferably below 13° C. The modulus of elasticity of the paint film after drying is less than 20 MPa, preferably less than 15 MPa.

This application claims priority of Netherlands Patent Application No. 1019786, filed Jan. 18, 2002, and U.S. Provisional patent application No. 60/366,645, filed Mar. 21, 2002.

### FIELD OF THE INVENTION

The invention pertains to a paint composition for a removable decorative coat of paint on a non-porous substrate and to a process for applying such a paint composition as a strippable decorative coat.

### BACKGROUND OF THE INVENTION

On special occasions such as international soccer competitions or national holidays, national colours are employed to add lustre to the festivities. Thus the Internet website www.metalak.nl/pers/pers1.htm and the periodical Autovisie®, 46^{th} edition, No. 15, Jul. 21, 2001, page 30, describe automotive coatings which can be used to provide a car with a temporary coat of paint, for instance for spraying it in the national colour(s) during an international soccer competition. The automotive coatings described in these publications are starch based compositions. The drawback to such starch based paints is that they are not water resistant. A shower or a washing suffices to wash off the coat of paint. The water disappears into the environment together with the traces of paint. Also, the special paint has to be sprayed in a professional spray booth for car repair coatings. It is thus impossible for the untrained user to apply the paint in a simple manner himself.

WO 97/45496 discloses a strip lacquer which primarily serves for temporary protection of surfaces, but which can also be used for temporary decoration. When applied on a smooth substrate, the lacquer forms a film which can be stripped off because it has an internal cohesion which exceeds its adhesion to the substrate.

### SUMMARY OF THE INVENTION

The present invention has for its object to provide a paint composition which is easy to apply on a non-porous substrate as a water resistant decorative coat which is easily removed, and which is particularly suitable for users in a consumer market. The paint film should be easily removable as a single strip even when relatively high pigment contents are used. The coat of paint has to be removable without recourse to means capable of damaging any underlying coat. The invention also has for its object a process for applying a removable decorative coat on a non-porous substrate.

### DETAILED DESCRIPTION OF THE INVENTION

The object of the invention is achieved with a paint composition for a strippable decorative coat on a non-porous substrate which is characterised in that it comprises one or more binders being a copolymer of a vinyl ester and a maleic ester. It has been found that such compositions allow application of a paint film which is easily strippable.

The lower the glass transition temperature of the coating applied, the easier it will be to remove the coat of paint in one go. Hence, the coat of paint according to the present invention preferably has a glass transition temperature Tg below 19° C., preferably below 13° C., most preferably below 9° C.

In order to obtain the desired glass transition temperature for the coat of paint, the paint composition preferably contains a polymeric binder having a Tg below 19° C., preferably below 13° C., most preferably below 9° C.

The flexibility of the coat of paint likewise has a favourable effect on its strippability. For that reason preferably use is made of a paint composition giving a coat of paint which after drying has a modulus of elasticity (E) of less than 20 MPa, preferably less than 15 MPa. Optimum results are obtained when the modulus of elasticity of the coat of paint is less than 11 MPa.

Co-polymers of vinyl acetate and dialkyl maleate are particularly suitable as binders. The equivalent ratio of vinyl acetate:dialkyl maleate monomer in the co-polymer generally is in the range of 1:1 to 10:1. The alkyl groups of the dialkyl maleate may be the same or different and generally have 1 to 8 carbon atoms. The dialkyl maleate preferably is dibutyl maleate. One example of a suitable commercially available binder is Mowilith® DM 2H from Clariant GmbH, Frankfurt, Germany.

The paint composition can contain organic solvents or be water borne. Water borne paint compositions are preferred, because they are suitable for use on a wider range of substrates and, e.g., will not attack the coat of paint of a passenger car as quickly. Furthermore, the health hazards for the user are lower, and water borne paint compositions have less impact on the environment. When the paint composition is water borne, it can contain up to 25 weight %, calculated on the binder, of organic solvent as co-solvent, e.g., glycols.

Examples of suitable processes for preparing the binder for aqueous paint compositions are aqueous emulsion polymerisation, as described in WO 00/39181, or solvent polymerisation followed by dissipation in water.

To achieve the desired colour, the paint composition contains one or more pigments, e.g., orange pigment. The pigments can be either organic or inorganic. The pigment content generally is in the range of 1 to 20 wt. %, calculated on the binder. Alternatively, the paint composition can contain dyes that are wholly or partially soluble in the paint composition.

The paint composition can contain additives such as fillers, levelling agents, emulsifiers, antifoaming agents, rheology control agents, antioxidants, UV-stabilisers, etc.

The paint composition can be prepared using various solids contents, which will generally be in the range of 20% to 80%, but are preferably in the range of 30% to 65%, depending on which method of application is selected.

The paint composition according to the invention can be applied in any known manner, preferably in a manner the untrained person finds easy to implement, e.g., application by means of a paint roller or by brushing.

Examples of suitable non-porous substrates are metals which may have been pretreated or not, pretreated wood, synthetic materials, and glass. Further suitable substrates are other coats of paint, such as are present on transport vehicles, e.g., passenger cars, bicycles, trains, trucks, and buses.

The applied paint composition can be dried at ambient temperature, more particularly, at a temperature of about −10° C. to about 50° C. No special facilities are needed for the paint to dry.

As was mentioned earlier, the paint compositions according to the invention are suitable for applying a decoration. Said decoration can encompass the entire outside surface of, say, the body of a passenger car, or it can be applied on only a part of the substrate, as will happen for instance with the text “Just Married”.

When the user wants to remove the temporary coat of paint again, the coat of paint according to the invention can easily be stripped off by hand. Stripping the paint off becomes easier still when the film is heated, e.g., after a treatment with warm water.

The invention will be elucidated further with reference to the following exemplified embodiments. In the examples the E-modulus is determined in accordance with ISO 527-1 and 527-3 with reference to paint films stripped from a glass substrate. The glass transition temperature Tg is determined by means of Differential Scanning Calorimetry (DSC), as described in Encyclopedia of Polymer Science and Engineering, Volume 4, pages 482-519, 1986 (Wiley Interscience). The percentages in the examples are percentages by weight calculated on the overall weight of the composition.

### EXAMPLE 1

A paint composition based on a water borne dispersion of a co-polymer of vinyl acetate and dibutyl maleate with a Tg of 5° C. (Mowilith® DM 2H) was prepared. The paint contained 3% of a white pigment (titanium dioxide), 0.8% of monoethylene glycol as co-solvent, and 0.5% of surfactants.

The paint was applied to a glass substrate. The film thickness was 143 micrometers. After drying the film could easily be stripped from the substrate in one piece. The modulus of elasticity equalled E=11 MPa. The Tg of the dried paint film was 5° C.

### EXAMPLE 2

A second paint composition based on Mowilithe DM 2H was prepared. The paint contained 4% of a yellow pigment (Hansa® yellow), 4% of monoethylene glycol as co-solvent, and 1% of surfactants.

The paint was applied to a glass substrate. The film thickness was 151 micrometers. After drying the film could easily be stripped from the substrate in one piece. The modulus of elasticity equalled E=9 MPa. The Tg of the dried paint film was 4° C.

1. A pigmented paint composition for coating a non-porous substrate with a strippable, decorative paint film having an internal cohesion exceeding its adhesion to the substrate, wherein the paint composition has at least one binder comprising a copolymer of a vinyl ester and a maleic ester.

2. A paint composition according to claim 1 wherein the vinyl ester is vinyl acetate.

3. A paint composition according to claim 1 wherein the maleic ester is a dialkyl maleate.

4. A paint composition according to claim 3 wherein the maleic ester is dibutyl maleate.

5. A paint composition according to claim 1 wherein the binder has a glass transition temperature below 19° C.

6. A paint composition according to claim 5 wherein the glass transition temperature of the binder is below 13° C.

7. A paint composition according to claim 1 wherein the paint composition forms a film having a glass transition temperature below 19° C.

8. A paint composition according to claim 7 wherein the glass transition temperature of the film is below 13° C.

9. A paint composition according to claim 1 wherein the paint composition forms a film having a modulus of elasticity of less than 20 Mpa.

10. A paint composition according to claim 9 wherein the modulus of elasticity is less than 15 MPa.

11. A paint composition according to claim 1 wherein the paint composition is a physically drying water borne latex.
